(19) United States
(12) Patent Application Publication
(10) Pub. No.: US 2011/0225011 A1
(43) Pub. Date: Sep. 15, 2011

(54) AUTHENTICATION OF A MOBILE USER OF AN ELECTRONIC PATIENT DIARY

(75) Inventors: Pekka Keskiivari, Box (FI); Rauha Tulkki-Wilke, Helsinki (FI)

(73) Assignee: CRF Box Oy, Helsinki (FI)

(21) Appl. No.: 13/047,467

(22) Filed: Mar. 14, 2011

(30) Foreign Application Priority Data
Mar. 15, 2010 (FI) 20105261

(51) Int. Cl. G06Q 50/00

(52) U.S. Cl. 705/3

(57) ABSTRACT

The invention allows authenticating a mobile user of an electronic patient diary effectively, conveniently and securely while keeping costs incurred on the patient to a minimum. Patient-reported data entered by a user and an identifier of the user are received at a patient-reported data collector. The received patient-reported data is stored as non-committed patient-reported data in response to the received identifier being successfully identified. A login request to the patient-reported data collector comprising login identification information of the user is received via a WWW-based service. In response to the user being successfully identified, the user is allowed access to review the stored non-committed patient-reported data, and to subsequently accept and/or reject the validity of the stored non-committed patient-reported data.

### BACKGROUND OF THE INVENTION

1. Field of the Invention

The invention relates generally to authentication of electronic patient diary users. In particular, the invention relates to methods, computer programs and apparatuses for authenticating an electronic patient diary user sending patient-reported data via mobile means.

2. Description of the Related Art

Today, clinical trials often obtain data directly from patients via patient diaries. This involves participating patients recording answers to validated questionnaires and symptoms occurrences, and/or recording other information about their condition.

Traditionally the patient diaries have been paper-based. However, there are problems with using paper-based patient diaries. For example, patients seldom record results at the time they are supposed to, resulting in collection of invalid and inaccurate data. To solve the problem, paper questionnaires have been increasingly replaced by electronic patient diaries.

Electronic patient diaries allow only registered patients to record data. Typically, they remind the patient to fill in the data at the right time and present only the questions the patient should answer at that time. In addition, they time stamp the recorded data and maintain an audit trail of changes to the data in order to ensure the integrity and validity of the data.

The use of electronic patient diaries is regulated by laws and guidelines from local authorities as well as GCP (Good Clinical Practice). These regulations typically require that patients are authenticated prior to entering the electronic patient diary to ensure that patient privacy is not compromised and to ensure that the data is recorded by the patient and not by someone else.

Prior art includes electronic patient diaries that are provided through Interactive Voice Response (IVR) systems that allow patients to complete questionnaires via telephone. However, such IVR based electronic patient diaries have significant drawbacks in that they are slow, unintuitive and inconvenient to use. Furthermore, the required telephone calls incur costs on the patients.

Prior art further includes electronic patient diaries that are provided through the Internet. In these solutions, the questionnaires are typically completed via a world wide web (WWW)-browser that resides on a personal computer or a laptop computer. However, such Internet based electronic patient diaries have significant drawbacks in that a patient seldom carries a computer with him/her all the time. Therefore, patients seldom record results at the time they are supposed to, resulting in collection of invalid and inaccurate data, similar to the paper-based patient diaries. This can be a particularly significant problem in clinical trials that collect event-driven data, e.g. the patient diary is used to record incidents that can happen at any time of the day. Some of these problems may be avoided if the WWW browser resides on a hand-held device, such as a smart phone. However, smart phones introduce their own problems, e.g. purchase costs associated with smart phones are still very high, excluding them from most patients. Furthermore, cellular Internet connections needed to use a WWW browser in a smart phone also typically incur high costs.

Prior art further includes electronic patient diaries that are provided through short message service (SMS) on a mobile telephone. However, such SMS based electronic patient diaries of prior art have significant drawbacks. In particular, such SMS based electronic patient diaries of prior art have significant drawbacks related to patient/user authentication. When patients report data by sending an SMS via a mobile phone, there must be a way to ensure no one else than the patient can send data to the clinical database. Currently this authentication is done by a) installing additional software on the mobile phone that enables authentication of patients before they send the SMS messages, b) using the devices' own personal identification number (PIN) and an automatic logout functionality to control the use of the device, or c) by having the patient send an SMS that includes his/her personal PIN code prior to answering the questions, or d) incorporating the PIN code or some other form of authentication in one of the messages.

However, each the above four authentication procedures have their associated issues. For example, installing additional software on mobile phones becomes a challenge from operational and systems validation points of view if patients use their own mobile phones, which is the intention in many studies where SMS is considered as a patient diary method. Using the devices' own PIN and automatic logout functionality cannot be controlled in between site visits, which makes it too unreliable for use in clinical studies. Having the patient send one additional SMS that includes the PIN is inconvenient for the patient and incurs additional costs. The patient has to wait for the response from the server to know that the authentication was successful; also it can be difficult to define the time authentication should be active, i.e. how long the system will accept data from the authenticated terminal. On the other hand, if the PIN is included in the data collection message, authentication can only be done while processing the collected data. If authentication fails, the patient must re-enter and resend the data.

Therefore, an object of the present invention is to alleviate the problems described above and to introduce a solution that allows authenticating a mobile user of an electronic patient diary effectively, conveniently and securely while keeping costs incurred on the patient to a minimum.

### SUMMARY OF THE INVENTION

A first aspect of the present invention is a method of authenticating a mobile user of an electronic patient diary. Patient-reported data and an identifier of a user are received at a patient-reported data collector. The patient-reported data has been entered by the user. In response to the received identifier of the user being successfully identified, the received patient-reported data is stored as non-committed patient-reported data. A login request to the patient-reported data collector is received at a world wide web-based service. The login request comprises login identification information of the user. In response to the user being successfully identified based on the received login identification information of the user, the user is allowed access to review the stored non-committed patient-reported data, and to subsequently perform at least one of accepting and rejecting the validity of at least a portion of the stored non-committed patient-reported data.

A second aspect of the present invention is a patient-reported data collector. The patient-reported data collector comprises a data receiver that is configured to receive patient-reported data entered by a user and further comprising an identifier of the user. The patient-reported data collector further comprises a first identification unit that is configured to identify the received identifier of the user. The patient-reported data collector further comprises a patient-reported data storage that is configured to store the received patient-reported data as non-committed patient-reported data in response to the received identifier of the user being successfully identified. The patient-reported data collector further comprises a world wide web-based server that is configured to receive a login request to the patient-reported data collector, wherein the login request comprises login identification information of the user. The patient-reported data collector further comprises a second identification unit that is configured to identify the user based on the received login identification information of the user. The patient-reported data collector further comprises a patient-reported data validator that is configured to allow the user access to review the stored non-committed patient-reported data, and to allow the user to subsequently perform at least one of accepting and rejecting the validity of at least a portion of the stored non-committed patient-reported data, in response to the user being successfully identified.

A third aspect of the present invention is a computer program for authenticating a mobile user of an electronic patient diary. The computer program comprises instructions which, when run in a patient-reported data collector, cause the patient-reported data collector to perform the steps of:

receiving, at the patient-reported data collector, patient-reported data entered by a user and an identifier of the user;

in response to successfully identifying the received identifier of the user:

storing the received patient-reported data as non-committed patient-reported data;

receiving a login request to the patient-reported data collector via a world wide web-based service, the login request comprising login identification information of the user; and

in response to successfully identifying the user based on the received login identification information of the user:

allowing the user access to review the stored non-committed patient-reported data, and to subsequently perform at least one of accepting and rejecting the validity of at least a portion of the stored non-committed patient-reported data.

A fourth aspect of the present invention is a patient-reported data collecting means. The patient-reported data collecting means comprises a data receiving means for receiving patient-reported data entered by a user and an identifier of the user. The patient-reported data collecting means further comprises a first identifying means for identifying the received identifier of the user. The patient-reported data collecting means further comprises a patient-reported data storing means for storing the received patient-reported data as non-committed patient-reported data in response to the received identifier of the user being successfully identified. The patient-reported data collecting means further comprises a world wide web based server means for receiving a login request to the patient-reported data collecting means, wherein the login request comprises login identification information of the user. The patient-reported data collecting means further comprises a second identifying means for identifying the user based on the received login identification information of the user. The patient-reported data collecting means further comprises a patient-reported data validating means for allowing the user access to review the stored non-committed patient-reported data, and for allowing the user to subsequently perform at least one of accepting and rejecting the validity of at least a portion of the stored non-committed patient-reported data, in response to the user being successfully identified.

In an embodiment of the invention, the receiving the patient-reported data further comprises receiving the patient-reported data via the world wide web-based service, wherein the received identifier of the user comprises one of the login identification information of the user and data related to a browser cookie stored on a terminal device of the user.

In an embodiment of the invention, the receiving the patient-reported data further comprises receiving the patient-reported data via a mobile messaging service message, wherein the received identifier of the user comprises a mobile subscriber identifier of the user comprised in the mobile messaging service message. In this embodiment of the invention, mobile subscriber identifiers of users allowed to use the electronic patient diary are stored, and the successfully identifying the received identifier of the user comprises finding the received mobile subscriber identifier from among the stored mobile subscriber identifiers.

In an embodiment of the invention, a username and an associated password are allocated as login identification information to users allowed to use the electronic patient diary, and the successfully identifying the user comprises finding the received login identification information from among the allocated login identification information.

In an embodiment of the invention, the accepting the validity of the at least a portion of the stored non-committed patient-reported data comprises digitally signing the portion of the stored non-committed patient-reported data.

In an embodiment of the invention, the at least a portion of the stored non-committed patient-reported data accepted by the user is changed to committed patient-reported data, and the at least a portion of the stored non-committed patient-reported data rejected by the user is discarded or marked as invalid.

In an embodiment of the invention, time lapsed since receiving the patient-reported data is monitored. In response to the lapsed time exceeding a predetermined threshold, a reminder message is sent to the user reminding the user to review the stored non-committed patient-reported data.

In an embodiment of the invention, the patient-reported data is received via a mobile messaging service message from a mobile terminal device. In this embodiment of the invention, the mobile messaging service message may be received via a cellular network.

It is to be understood that the aspects and embodiments of the invention described above may be used in any combination with each other. Several of the aspects and embodiments may be combined together to form a further embodiment of the invention. A method, an patient-reported data collector, or a computer program which is an aspect of the invention may comprise at least one of the embodiments of the invention described above.

The invention allows authenticating a mobile user of an electronic patient diary effectively, conveniently and securely while keeping costs incurred on the patient to a minimum. The invention provides a user-friendly way for authentication of patients, particularly in studies that collect event-driven data, e.g. the electronic patient diary is used to record incidents that can happen at any time of the day. Allowing the patient to use his/her normal mobile phone to record the data points makes the system easy to use, and removes the need to temporarily record data and to remember enter it later into the system, since the patient is likely to carry his/her mobile phone with him/her at all times.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1a is a flow diagram illustrating a method according to an embodiment of the invention;

FIG. 1b is a flow diagram illustrating steps 103-104 of FIG. 1a in more detail according to an embodiment of the invention;

FIG. 1c is a flow diagram illustrating steps 103-104 of FIG. 1a in more detail according to another embodiment of the invention; and

FIG. 2 is a block diagram illustrating an patient-reported data collector according to an embodiment of the invention as deployed in connection with various communications networks.

### DETAILED DESCRIPTION OF THE PREFERRED EMBODIMENTS

Reference will now be made in detail to the embodiments of the invention, examples of which are illustrated in the accompanying drawings.

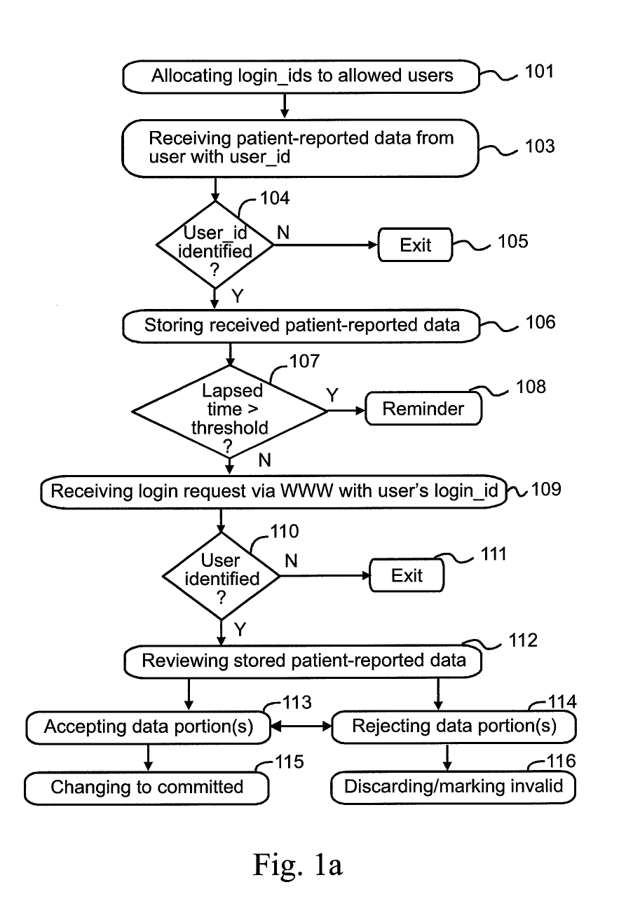

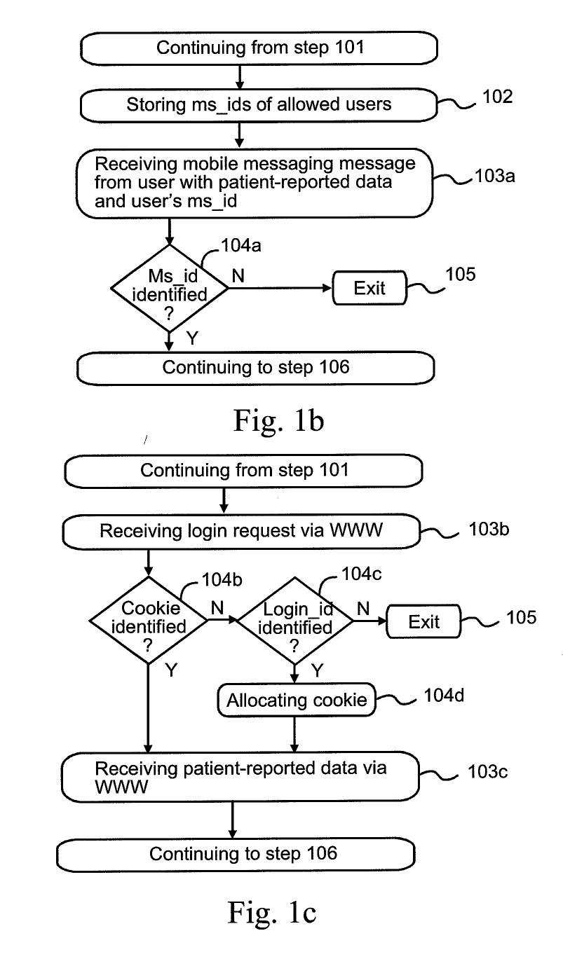

FIG. 1a is a flow diagram illustrating a method of authenticating a mobile user of an electronic patient diary according to an embodiment of the invention. FIG. 1b is a flow diagram illustrating steps 103-104 of FIG. 1a in more detail according to an embodiment of the invention, and FIG. 1c is a flow diagram illustrating steps 103-104 of FIG. 1a in more detail according to another embodiment of the invention.

At an optional step 101, login identification information may be allocated to users allowed to use an electronic patient diary. The identification information may comprise e.g. a username and an associated password. Herein, the term “user” refers to a person (such as e.g. a patient, a guardian of the patient, a care giver of the patient, or an observer of the patient) using an electronic patient diary to record and submit patient-reported data (such as e.g. patient diary data or other related clinical data) for use in e.g. clinical trials run by e.g. pharmaceutical industry. Typically, the user needs to be registered before allowed in the clinical trial. Step 101 may be performed by e.g. a doctor or other personnel associated with the clinical trial in question. Herein, the term “mobile” in “mobile user” indicates that the user utilizes a mobile terminal device (such as e.g. a mobile telephone/smart phone, a personal digital assistant, or a laptop computer) to send the patient-reported data.

Then, patient-reported data and an identifier of the user are received at a patient-reported data collector, step 103. The patient-reported data is entered by the user. That is, the patient-reported data is recorded by the user who sends the data to the patient-reported data collector. The user may e.g. reply to a previous message sent by the patient-reported data collector, and/or the in the embodiment in which the patient-reported data is sent via a mobile messaging service (see the description of FIG. 1b below), the user may send the mobile messaging service message to a specific short code. The patient-reported data may be e.g. a short numeric or text value, such as PEF entry “567” or “No”.

At step 104, identification of the received identifier of the user is attempted. If the received identifier is successfully identified, the method of FIG. 1a proceeds to step 106. Otherwise, the method of FIG. 1a exits, step 105. An object of the identification of step 104 is to determine whether the patient-reported data received at step 103 originates from a patient who is participating in a study/clinical trial. In addition, the identification of step 104 may be used to determine to which patient and protocol the received patient-reported data belongs to.

FIGS. 1b-1c illustrate alternative implementations of steps 103-104 of FIG. 1a. FIG. 1b relates to an embodiment utilizing a mobile messaging service, and FIG. 1c relates to an embodiment utilizing a world wide web-based service.

Referring first to FIG. 1b, at an optional step 102, mobile subscriber identifiers of those users that are allowed to use the electronic patient diary may be stored. The mobile subscriber identifier refers to an identifier assigned to a user for his/her mobile telephony subscription. The mobile subscriber identifier may include e.g. a mobile subscriber integrated services digital network number (MSISDN) assigned to the user. Step 102 can be performed e.g. by the user or patient entering his/her mobile subscriber identifier for storage. Alternatively, this can be done by e.g. a doctor or other personnel associated with the clinical trial in question. The order in which steps 101 and 102 are performed, is not relevant. In other words, step 102 may be performed prior to step 101.

At step 103a, the patient-reported data is received via a mobile messaging service message. In the embodiment of FIG. 1b, the received identifier of the user comprises a mobile subscriber identifier (e.g. the mobile subscriber integrated services digital network number (MSISDN) described above) of the user which is comprised in the mobile messaging service message. The mobile messaging service message may be any suitable mobile messaging service message, including but not limited to a short message service (SMS) message, a multimedia messaging service (MMS) message, enhanced messaging service (EMS) message, and a mobile instant messaging (MIM) message.

At step 104a, identification of the received mobile subscriber identifier of the user is attempted. The identification of step 104a may be achieved by searching for the received mobile subscriber identifier from among the mobile subscriber identifiers that were stored at step 102. If the received mobile subscriber identifier is found among the previously stored mobile subscriber identifiers, the received mobile subscriber identifier has been successfully identified, and the method of FIG. 1b proceeds to step 106 of FIG. 1a. Otherwise, the method of FIG. 1b exits, step 105.

Referring now to FIG. 1c, the patient-reported data is received via a world wide web-based service, and the received identifier of the user may comprise data related to a browser cookie previously stored on the terminal device of the user. Alternatively, the received identifier of the user may comprise login identification information of the user. At step 103b, a login request is received via the world wide web-based service. The login request may comprise e.g. the user entering a pre-determined uniform resource locator (URL) address with his/her web browser, wherein the URL is associated with the patient-reported data collector, and more particularly with the world wide web-based service implemented therein. Furthermore, the URL may be user-specific so that each user is allocated his/her own URL via which to login. Alternatively, the URL may be e.g. clinical trial-specific so that each user in a given clinical trial is allocated a same URL via which to login.

If the user has previously transmitted patient-reported data according to the embodiment of FIG. 1c, a browser cookie may have been stored on the terminal device of the user (such as e.g. a mobile telephone/smart phone, a personal digital assistant, or a laptop computer). As is known in the art, a browser cookie (also known as a cookie, and an HTTP cookie) is a small piece of text stored on a user's terminal device by a web browser. A cookie may consist of e.g. one or more name-value pairs containing bits of information. At step 104b, identification of data related to such a browser cookie previously stored on the terminal device of the user is attempted.

If the identification of step 104b succeeds, the method of FIG. 1c proceeds to step 103c. Otherwise, the method of FIG. 1c proceeds to step 104c in which the user is asked for his/her login identification information (e.g. the username and its associated password described above in connection with step 101 of FIG. 1a). If the received login identification information is identified e.g. by finding it among the previously allocated identification information, the identification succeeds, and the method of FIG. 1c may proceed to optional step 104d or directly to step 103c. Otherwise, the identification fails, and the method of FIG. 1c exits, step 105. At the optional step 104d, a browser cookie may be allocated to the user and stored on the terminal device of the user. Also, in place of the browser cookie, similar user-specific identification data may be used. Allocating the cookie at step 104d allows the user to be identified based on the allocated cookie the next time when patient-reported data is received from the same terminal device of the user, thereby speeding up the next identification process (and making it more user-friendly) due to not needing to ask and enter the login identification information each time new patient-reported data is submitted. Yet, due to the separate data validation process of steps 109-116 (described below), data integrity and validity required by various laws and authorities is maintained.

After step 104b or 104d, the method of FIG. 1c proceeds to step 103c in which the patient-reported data is received via the world wide web-based service. For example, the user may enter the patient-reported data via the same URL via which he/she logged in at step 103b.

If the received identifier of the user is successfully identified, the method proceeds to step 106 in which the received patient-reported data is stored as non-committed patient-reported data. The specific storage location may be determined based on the identifier of the user received at step 103, 103a or 103b. The term “non-committed” as used herein indicates that the patient-reported data stored in step 106 has not yet been validated by its sender and thus is not yet considered valid clinical source data.

Steps 103-106 may be repeated multiple times. That is, the user/patient may send multiple subsequent sets of patient-reported data, each comprising different patient-reported data entered by the user.

Optionally, the time lapsed since receiving the patient-reported data may be monitored step 107. If the lapsed time exceeds a predetermined threshold, a reminder message (e.g. an email message or an SMS message) may be sent to the user reminding the user to review the stored non-committed patient-reported data, step 108.

Then, a login request to the patient-reported data collector is received via the world wide web based service of the patient-reported data collector, step 109. The login request comprises user's login identification information (e.g. the above described username and its associated password as entered by the user via a world wide web-based interface (such as a WWW browser deployed e.g. in a WWW-enabled smart phone or a personal digital assistant, a desktop computer or a laptop computer of the user)).

At step 110, identification of the user trying to login is attempted. In an embodiment, this is achieved by searching the received login identification information (e.g. the username and its associated password entered by the user) from among the login identification information that was allocated at step 101. If the received login identification information is found among the previously allocated login identification information, the user has been successfully identified, and the method of FIG. 1a proceeds to step 112. Otherwise, the method of FIG. 1a exits, step 111.

In response to the user being successfully identified based on the received login identification information, the method of FIG. 1a proceeds to step 112 in which the user is allowed access to review the stored non-committed patient-reported data. The user is also allowed to accept the validity of at least a portion of the stored non-committed patient-reported data, step 113. Furthermore, the user is allowed to reject the validity of at least a portion of the stored non-committed patient-reported data, step 114. The patient-reported data collector may prompt the user to review and validate each data entry.

In an embodiment, the accepting the validity of the at least a portion of the stored non-committed patient-reported data of step 113 comprises the user digitally signing the relevant portion(s) of the stored non-committed patient-reported data. The at least a portion of the stored non-committed patient-reported data accepted by the user may be changed (i.e. its status may be changed) to committed patient-reported data so that it is considered valid clinical source data, step 115, whereas the at least a portion of the stored non-committed patient-reported data rejected by the user may be discarded or marked as invalid, step 116.

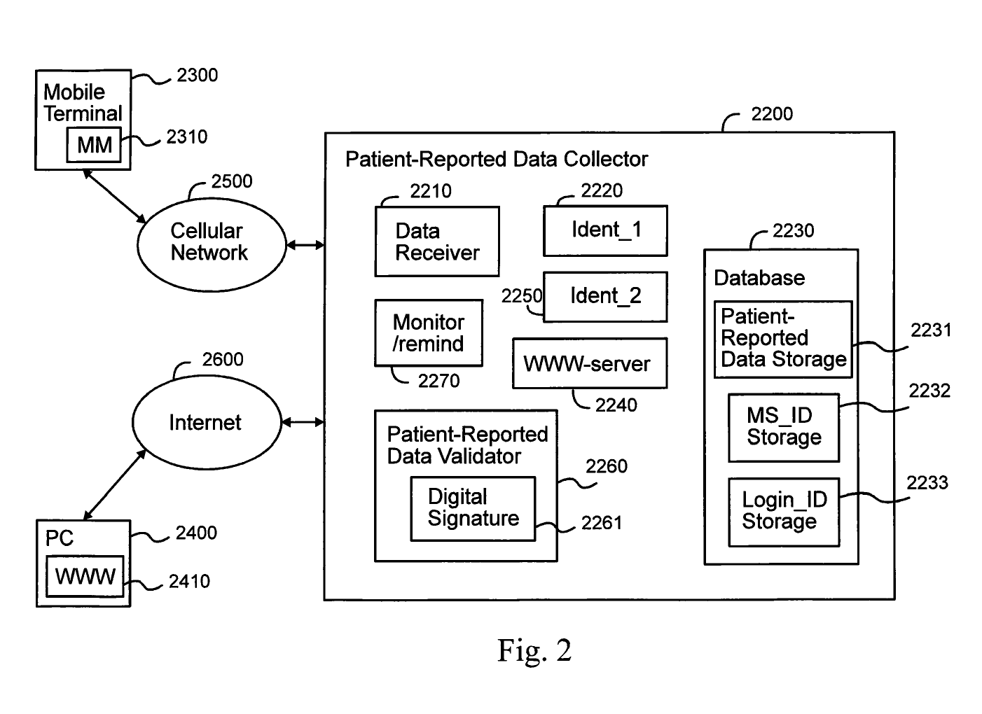

FIG. 2 is a block diagram illustrating an patient-reported data collector 2200 according to an embodiment of the invention as deployed in connection with various communications networks.

The arrangement of FIG. 2 comprises a mobile terminal device 2300 that includes a mobile messaging service means 2310. The mobile terminal device 2300 may be e.g. a conventional cellular telephone that includes mobile messaging service capability. The user/patient may utilize the mobile terminal device 2300 to communicate with the patient-reported data collector 2200 of the invention via a cellular network 2500. The cellular network 2500 may be e.g. a Global System for Mobile Communications (GSM) network, a 3rd Generation Partnership Project (3GPP), and/or a code division multiple access (CDMA) based network including wideband code division multiple access (W-CDMA) based networks and international mobile telecommunications-2000 (IMT-2000) based networks. The mobile messaging service means 2310 may include e.g. short message service (SMS) capability, multimedia messaging service (MMS) capability, enhanced messaging service (EMS) capability, and/or mobile instant messaging (MIM) capability.

The arrangement of FIG. 2 further comprises an internet protocol (IP) and world wide web (WWW) enabled computing device 2400 that includes a world wide web interface/browser 2410. In an embodiment, the computing device 2400 may be e.g. a conventional personal computer or a desktop computer that includes world wide web-browsing capability. In another embodiment, mobile terminal device 2300 and the computing device 2400 may be integrated e.g. into a smart phone with world wide web-browsing capability. The user/patient will utilize the computing device 2400 to communicate with the patient-reported data collector 2200 of the invention via an internet protocol based network 2600 (such as e.g. the Internet).

The arrangement of FIG. 2 further comprises the patient-reported data collector 2200 of the invention. The patient-reported data collector 2200 comprises a data receiver 2210 that is configured to receive patient-reported data entered by a user and an identifier of the user. The data receiver 2210 may be further configured to receive said patient-reported data via a world wide web-based server 2240, wherein the received identifier of the user comprises one of the login identification information of the user and data related to a browser cookie stored on a terminal device 2300, 2400 of the user. Alternatively, the data receiver 2210 may be further configured to receive the patient-reported data via a mobile messaging service message, wherein the received identifier of the user comprises a mobile subscriber identifier of the user comprised in the mobile messaging service message. In the latter case, the data receiver 2210 may be further configured to receive the mobile messaging service message from the mobile terminal device 2300 via the cellular network 2500.

The patient-reported data collector 2200 further comprises a first identification unit 2220 that is configured to identify the received identifier of the user. The patient-reported data collector 2200 may further comprise a mobile subscriber identifier storage 2232 that is configured to store mobile subscriber identifiers of users allowed to use the patient-reported data collector 2200. In an embodiment, the first identification unit 2220 is configured to perform the identification of the received identifier of the user by finding the received mobile subscriber identifier from among the stored mobile subscriber identifiers.

The patient-reported data collector 2200 further comprises a patient-reported data storage 2231 that is configured to store the received patient-reported data as non-committed patient-reported data in response to the received identifier of the user being successfully identified.

The patient-reported data collector 2200 further comprises a world wide web-based server 2240 that is configured to receive a login request to the patient-reported data collector 2200, wherein the login request comprises login identification information of the user. The login request may be received e.g. from the computing device 2400 via the internet protocol based network 2600.

The patient-reported data collector 2200 further comprises a second identification unit 2250 that is configured to identify the user based on the received login identification information. The patient-reported data collector 2200 may further comprise a login identification information storage 2233 configured to store a user-specific username and an associated password as login identification information-allocated to users allowed to use the electronic patient diary. The second identification unit 2250 may be configured to perform the identification of the user by finding the received login identification information from among the stored login identification information.

As illustrated in FIG. 2, the patient-reported data collector 2200 may further comprise a storage 2230 (such as e.g. a database) that includes the patient-reported data storage 2231, the mobile subscriber identifier storage 2232 and the login identification information storage 2233. Alternatively, the patient-reported data storage 2231, the mobile subscriber identifier storage 2232 and the login identification information storage 2233 may be arranged as separate entities.

Similarly, the first identification unit 2220 and the second identification unit 2250 may be implemented as separate entities, or they may be integrated to a single entity.

The patient-reported data collector 2200 further comprises a patient-reported data validator 2260 that is configured to allow the user access to review the stored non-committed patient-reported data, and to allow the user to subsequently perform at least one of accepting and rejecting the validity of at least a portion of the stored non-committed patient-reported data, in response to the user being successfully identified. The patient-reported data validator 2260 may further comprise a digital signature unit 2261 configured to allow the user to perform the accepting the validity of the at least a portion of the stored non-committed patient-reported data by digitally signing the portion of the stored non-committed patient-reported data. The patient-reported data validator 2260 may be further configured to change the at least a portion of the stored non-committed patient-reported data accepted by the user to committed patient-reported data, and to discard or mark as invalid the at least a portion of the stored non-committed patient-reported data rejected by the user.

The patient-reported data collector 2200 may further comprise a lapsed time monitor 2270 configured to monitor time lapsed since the last receipt of the patient-reported data, and in response to the lapsed time exceeding a predetermined threshold, to send a reminder message to the user to review the stored non-committed patient-reported data.

Each of the various functional elements of FIG. 2 described above may be implemented in software, in hardware, or as a combination of software and hardware.

The exemplary embodiments can include, for example, any suitable servers, workstations, PCs, laptop computers, personal digital assistants (PDAs), Internet appliances, handheld devices, cellular telephones, smart phones, wireless devices, other devices, and the like, capable of performing the processes of the exemplary embodiments. The devices and subsystems of the exemplary embodiments can communicate with each other using any suitable protocol and can be implemented using one or more programmed computer systems or devices.

One or more interface mechanisms can be used with the exemplary embodiments, including, for example, Internet access, telecommunications in any suitable form (e.g., voice, modem, and the like), wireless communications media, and the like. For example, employed communications networks or links can include one or more wireless communications networks, cellular communications networks, 3 G communications networks, Public Switched Telephone Network (PSTNs), Packet Data Networks (PDNs), the Internet, intranets, a combination thereof, and the like.

It is to be understood that the exemplary embodiments are for exemplary purposes, as many variations of the specific hardware used to implement the exemplary embodiments are possible, as will be appreciated by those skilled in the hardware and/or software art(s). For example, the functionality of one or more of the components of the exemplary embodiments can be implemented via one or more hardware and/or software devices.

The exemplary embodiments can store information relating to various processes described herein. This information can be stored in one or more memories, such as a hard disk, optical disk, magneto-optical disk, RAM, and the like. One or more databases can store the information used to implement the exemplary embodiments of the present inventions. The databases can be organized using data structures (e.g., records, tables, arrays, fields, graphs, trees, lists, and the like) included in one or more memories or storage devices listed herein. The processes described with respect to the exemplary embodiments can include appropriate data structures for storing data collected and/or generated by the processes of the devices and subsystems of the exemplary embodiments in one or more databases.

All or a portion of the exemplary embodiments can be conveniently implemented using one or more general purpose processors, microprocessors, digital signal processors, micro-controllers, and the like, programmed according to the teachings of the exemplary embodiments of the present inventions, as will be appreciated by those skilled in the computer and/or software art(s). Appropriate software can be readily prepared by programmers of ordinary skill based on the teachings of the exemplary embodiments, as will be appreciated by those skilled in the software art. In addition, the exemplary embodiments can be implemented by the preparation of application-specific integrated circuits or by interconnecting an appropriate network of conventional component circuits, as will be appreciated by those skilled in the electrical art(s). Thus, the exemplary embodiments are not limited to any specific combination of hardware and/or software.

Stored on any one or on a combination of computer readable media, the exemplary embodiments of the present inventions can include software for controlling the components of the exemplary embodiments, for driving the components of the exemplary embodiments, for enabling the components of the exemplary embodiments to interact with a human user, and the like. Such software can include, but is not limited to, device drivers, firmware, operating systems, development tools, applications software, and the like. Such computer readable media further can include the computer program product of an embodiment of the present inventions for performing all or a portion (if processing is distributed) of the processing performed in implementing the inventions. Computer code devices of the exemplary embodiments of the present inventions can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the exemplary embodiments of the present inventions can be distributed for better performance, reliability, cost, and the like.

As stated above, the components of the exemplary embodiments can include computer readable medium or memories for holding instructions programmed according to the teachings of the present inventions and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CD±R, CD±RW, DVD, DVD-RAM, DVD±RW, DVD±R, HD DVD, HD DVD-R, HD DVD-RW, HD DVD-RAM, Blu-ray Disc, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read.

While the present inventions have been described in connection with a number of exemplary embodiments, and implementations, the present inventions are not so limited, but rather cover various modifications, and equivalent arrangements, which fall within the purview of prospective claims.

1. A method of authenticating a mobile user of an electronic patient diary comprising:
receiving, at a patient-reported data collector, patient-reported data entered by a user and an identifier of said user;
in response to successfully identifying said received identifier of said user:
storing said received patient-reported data as non-committed patient-reported data;
receiving a login request to said patient-reported data collector via a world wide web-based service, said login request comprising login identification information of said user; and
in response to successfully identifying said user based on said received login identification information of said user:
allowing said user access to review said stored non-committed patient-reported data, and to subsequently perform at least one of accepting and rejecting the validity of at least a portion of said stored non-committed patient-reported data.

2. The method according to claim 1, wherein receiving said patient-reported data further comprises receiving said patient-reported data via said world wide web-based service, wherein said received identifier of said user comprises one of said login identification information of said user and data related to a browser cookie stored on a terminal device of said user.

3. The method according to claim 1, wherein receiving said patient-reported data further comprises receiving said patient-reported data via a mobile messaging service message, wherein said received identifier of said user comprises a mobile subscriber identifier of said user comprised in said mobile messaging service message.

4. The method according to claim 3, further comprising:
storing mobile subscriber identifiers of users allowed to use said electronic patient diary;
wherein said successfully identifying said received identifier of said user comprises finding said received mobile subscriber identifier from among said stored mobile subscriber identifiers.

5. The method according to claim 1, further comprising:
allocating a username and an associated password as login identification information to users allowed to use said electronic patient diary;
wherein said successfully identifying said user comprises finding said received login identification information from among said allocated login identification information.

6. The method according to claim 1, wherein accepting the validity of the at least a portion of said stored non-committed patient-reported data comprises digitally signing said portion of said stored non-committed patient-reported data.

7. The method according to claim 1, wherein the method further comprises changing the at least a portion of said stored non-committed patient-reported data accepted by said user to committed patient-reported data, and discarding or marking as invalid the at least a portion of said stored non-committed patient-reported data rejected by said user.

8. The method according to claim 1, further comprising:
monitoring time lapsed since said receiving said patient-reported data; and
in response to said lapsed time exceeding a predetermined threshold, sending a reminder message to said user to review said stored non-committed patient-reported data.

9. A patient-reported data collector, comprising:
a data receiver configured to receive patient-reported data entered by a user and an identifier of said user;
a first identification unit configured to identify said received identifier of said user;
a patient-reported data storage configured to store said received patient-reported data as non-committed patient-reported data in response to said received identifier of said user being successfully identified;
a world wide web-based server configured to receive a login request to said patient-reported data collector, said login request comprising login identification information of said user;
a second identification unit configured to identify said user based on said received login identification information of said user; and
a patient-reported data validator configured, in response to said user being successfully identified, to allow said user access to review said stored non-committed patient-reported data, and to allow said user to subsequently perform at least one of accepting and rejecting the validity of at least a portion of said stored non-committed patient-reported data.

10. The patient-reported data collector according to claim 9, wherein said data receiver is further configured to receive said patient-reported data via said world wide web-based server, wherein said received identifier of said user comprises one of said login identification information of said user and data related to a browser cookie stored on a terminal device of said user.

11. The patient-reported data collector according to claim 9, wherein said data receiver is further configured to receive said patient-reported data via a mobile messaging service message, wherein said received identifier of said user comprises a mobile subscriber identifier of said user comprised in said mobile messaging service message.

12. The patient-reported data collector according to claim 11, wherein the patient-reported data collector further comprises:
a mobile subscriber identifier storage configured to store mobile subscriber identifiers of users allowed to use a predetermined electronic patient diary;
wherein said first identification unit is configured to perform said identification of said received identifier of said user by finding said received mobile subscriber identifier from among said stored mobile subscriber identifiers.

13. The patient-reported data collector according to claim 9, wherein the patient-reported data collector further comprises:
a login identification information storage configured to store a username and an associated password as login identification information allocated to users allowed to use a predetermined electronic patient diary;
wherein said second identification unit is configured to perform said identification of said user by finding said received login identification information from among said stored login identification information.

14. The patient-reported data collector according to claim 9, wherein the patient-reported data validator further comprises:
a digital signature unit configured to allow said user to perform said accepting the validity of the at least a portion of said stored non-committed patient-reported data by digitally signing said portion of said stored non-committed patient-reported data.

15. The patient-reported data collector according to claim 9, wherein the patient-reported data validator is further configured to change the at least a portion of said stored non-committed patient-reported data accepted by said user to committed patient-reported data, and to discard or mark as invalid the at least a portion of said stored non-committed patient-reported data rejected by said user.

16. The patient-reported data collector according to claim 9, wherein the patient-reported data collector further comprises:
a lapsed time monitor configured to monitor time lapsed since said receipt of said patient-reported data, and in response to said lapsed time exceeding a predetermined threshold, to send a reminder message to said user to review said stored non-committed patient-reported data.

17. The patient-reported data collector according to claim 11, wherein said data receiver is further configured to receive said patient-reported data via said mobile messaging service message from a mobile terminal device via a cellular network.

18. A computer program for authenticating a mobile user of an electronic patient diary, comprising instructions which, when run in an patient-reported data collector, cause the patient-reported data collector to perform the steps of:
receiving, at a patient-reported data collector, patient-reported data entered by a user and an identifier of said user;
in response to successfully identifying said received identifier of said user:
storing said received patient-reported data as non-committed patient-reported data;
receiving a login request to said patient-reported data collector via a world wide web-based service, said login request comprising login identification information of said user; and
in response to successfully identifying said user based on said received login identification information:
allowing said user access to review said stored non-committed patient-reported data, and to subsequently perform at least one of accepting and rejecting the validity of at least a portion of said stored non-committed patient-reported data.
